(19) United States
(12) Patent Application Publication
(10) Pub. No.: US 2024/0252848 A1
(43) Pub. Date: Aug. 1, 2024

(54) COLLAPSIBLE PROTECTIVE RESPIRATORY MASK

(71) Applicant: D. Wheatley Enterprises, Inc., Belcamp, MD (US)

(72) Inventors: Patrick Hulbert, Dallastown, PA (US); Robert Elliott, Bel Air, MD (US); Ken Ikemoto, Belcamp, MD (US)

(21) Appl. No.: 18/430,299

(22) Filed: Feb. 1, 2024

Related U.S. Application Data
(60) Provisional application No. 63/482,657, filed on Feb. 1, 2023.

(51) Int. Cl. A62B 9/00; A62B 18/08; A62B 18/10; A62B 23/02

(52) U.S. Cl. CPC A62B 9/006; A62B 9/00; A62B 18/082; A62B 18/086; A62B 18/10; A62B 23/02

(57) ABSTRACT

A collapsible respiratory mask includes a flexible main body having a face-engaging flange that provides a continuous seal against a wearer's face and viewing windows that provide full peripheral vision to maximize the wearer's field of view. Filter panels are provided on opposite sides of the mask that allow for single-use disposable or replaceable assemblies, and each comprise a multi-layer assembly sewn around the perimeter with a fluorescent thread. A urethane gasket encloses the perimeter with the fluorescent thread viewable from inside of the gasket under ultraviolet light. An inner nose cup guides air that is inhaled through the filter panels past the viewing windows and into a separated air compartment inside of the nose cup, creating an airflow that minimizes fogging on the interior of the viewing windows. The mask is equipped with straps configured to enable a wearer to don the mask alone or with a protective helmet by attachment to a rail on the helmet.

### CROSS-REFERENCE TO RELATED APPLICATIONS

This application claims the benefit of U.S. Provisional Patent Application No. 63/482,657 titled “COLLAPSIBLE PROTECTIVE RESPIRATORY MASK,” filed by the Applicant herein on Feb. 1, 2023, the specification of which is incorporated herein by reference in its entirety.

### FIELD OF THE INVENTION

This invention relates generally to personal protective equipment, and more particularly to easy-to-use and apply protective equipment for protecting a user against inhalation, ingestion, and general exposure to environmental contaminants, and that can be flat-folded for easy and compact storage and carrying until needed.

### BACKGROUND OF THE INVENTION

Personal protective equipment (PPE) serves as a critical line of defense for individuals facing potential exposure to a diverse range of environmental contaminants. In recent decades, the increasing complexity and diversity of environmental hazards have created a heightened need for sophisticated PPE. Professionals across various sectors, including healthcare, emergency response, and military operations, often confront environments where airborne chemical, biological, or radiological agents pose serious threats. For healthcare workers, the ongoing risks of contagious diseases and emerging pathogens underline the need for robust protective measures. Similarly, emergency first responders and military personnel may encounter scenarios involving chemical spills, terrorist attacks, or natural disasters where exposure to hazardous substances is a significant concern.

Traditionally, respiratory protection has been provided by various types of masks and respirators ranging from simple face masks to more advanced respirators with filtration systems. However, the effectiveness of existing solutions is often compromised by challenges such as limited protection spectrum, cumbersome designs, and difficulties in quick deployment. Powered systems or self-contained breathing apparatuses, while effective, may have drawbacks such as restricted operating duration, considerable size and weight, and the time required for application or replacement.

Moreover, the adaptability of existing respiratory protection equipment to diverse environments remains a persistent challenge. Certain environments may demand rapid deployment and prolonged use, requiring PPE that is not only highly effective but also user-friendly, lightweight, and easily storable. The need for a balance between protection and practicality has thus far been unmet by solutions that can seamlessly integrate into professionals' workflows without compromising safety.

Thus, there is continuing need for respiratory masks that provide comprehensive protection against a broad range of environmental contaminants, and particularly respiratory masks that not only offer high-level filtration, but that are additionally easy to carry, deploy, and wear for extended periods, that are capable of addressing the specific challenges faced by different user groups, and that align with those different user groups' operational needs.

### SUMMARY OF THE INVENTION

In accordance with certain aspects of the invention, a collapsible protective respiratory mask is disclosed that is configured for efficient storage, rapid deployment, and effective protection against various environmental contaminants. The mask is formed of a flexible material that both enables flat folding and compact storage of the mask, while simultaneously providing protection against contaminants, such as (by way of non-limiting example) tear gas and CS gas, ensuring the wearer's safety in hazardous conditions. Protective respiratory masks configured in accordance with at least certain aspects of the invention provide ease of use, efficient storage, and effective respiratory protection for use in a variety of hazardous environments.

In addition to providing a readily collapsible configuration, the mask is configured to provide a continuous seal around the wearer's face, and provides viewing windows that maximize the wearer' field of view, and in particular embodiments offer a field of view capturing more than 90°, and more preferably at least 110°, in each direction from a centerline between the wearer's eyes in order to minimize and hinderance to the wearer's peripheral vision.

In accordance with further aspects of an embodiment, air enters into the mask through filter panels comprised of readily available materials, thus making the mask economically suitable for single-use as a disposable option after exposure to a contaminated environment. Nonetheless, in certain configurations the filter panels may be provided as removeable and replaceable modular units, thus allowing for repeated use of the mask.

In accordance with further aspects of an embodiment, the respiratory mask includes an inner nose cup that sits inside the main body of the mask to position an interior rim of the inner nose cup snugly against the wearer's face. The inner nose cup is configured such that air inhaled through filter panels is drawn into a first enclosed air space between the inner nose cup and the main body of the mask, and from there into the inner nose cup, with air flowing past the interior of the viewing windows to minimize or altogether eliminate fogging of the lenses of the viewing windows. Further, exhaled air is primarily directed through an outlet valve in the inner nose cup to further aid in minimizing fogging of the lenses of the viewing windows. In certain exemplary configurations, the inner nose cup may also incorporate communications and hydration ports, enabling sealed pass-through hydration and connection to external and internal communication equipment.

In order to secure the mask on the user, and in accordance with further aspects of an embodiment, straps extend outward from the main body and include buckles that may join to one another and that likewise may be attached to a rail on a protective helmet or other headgear. This configuration provides flexibility in adjusting the mask's position to achieve the best fit for the user, while also enabling donning of the mask whether or not a helmet is worn.

The filter panels are constructed from multiple layers of various distinct materials, including a layer of scratch-resistant mesh, spandex mesh, electrostatic filter media (such as, by way of non-limiting example, TECHNOSTAT filter media), carbon cloth, and additional spandex mesh. The layers are stitched together, forming a border that is encapsulated with a urethane gasket in a mold. This meticulous manufacturing process ensures the integrity of the filter panels, preventing pinholes that could compromise their effectiveness.

In accordance with aspects of an embodiment of the invention, a protective respiratory mask is provided comprising: a main body constructed from a thermoplastic elastomer material, the main body including an anatomically contoured face-engaging flange configured to conform to the contours of a wearer's face to provide a hermetic seal; a pair of viewing windows integrated into the main body, each window configured to provide a field of view capturing great than 90° in each direction from a centerline between the wearer's eyes; a plurality of filter panels attached to the main body on opposite sides, each filter panel comprising multiple layers of filtration material including an electrostatic filter media and a carbon cloth layer, the filter panels configured to allow air passage into the mask while filtering environmental contaminants; an inner nose cup positioned within the main body and having an interior rim designed to sit flush against the wearer's face, the inner nose cup including an air opening for directing inhaled air from an interior side of the filter panels into the interior of the inner nose cup; an outlet valve integrated with the inner nose cup for directing exhaled air out of the mask; and a set of straps extending outward from the main body for securing the mask to the wearer's head.

The filter panels may further comprise an outer layer of abrasion-resistant polymeric mesh, an inner layer of spandex mesh, and a urethane gasket encapsulating the perimeter of the filter panels. The urethane gasket encapsulating the perimeter of the filter panels may be formed using a liquid injection molding process that ensures airtight sealing and prevents delamination of the filter panel layers. Further, the outer layer of the filter panels may be reinforced with a tear-resistant weave pattern that maintains structural integrity even when subjected to rough handling or snagging.

The filter panels may be constructed as modular units that are detachably coupled to the main body, each modular unit comprising a frame and a multi-layered filtration assembly, the frame configured to enable quick replacement of the filtration assembly for repeated use of the mask following contamination exposure.

The inner nose cup may further comprise an integrated communications interface with a port configured to establish a sealed connection with external communication devices, and a hydration port configured to establish a sealed connection with an external hydration source.

The straps may include adjustable buckles with locking mechanisms, the buckles being configured for secure engagement with a standardized rail system on a protective helmet or other headgear. The straps may also include a fine-adjustment mechanism that allows for incremental tightening or loosening to achieve a custom fit for various head sizes and shapes.

The main body and the inner nose cup may be formed of a thermoplastic elastomer material protective against environmental contaminants including tear gas and CS gas.

The mask may be collapsible along a midline of the mask for compact, flat storage and rapid deployment.

The filter panels may be stitched with a fluorescent thread around an outer perimeter of each filter panel. The thread may e encased in a urethane gasket encapsulating a perimeter of each of the filter panels, wherein the thread is visible through the gasket under ultraviolet light to ensure the integrity of the filter panels.

The outlet valve may comprise a one-way exhalation valve configured to prevent inflow of air and to direct exhaled air out of the mask, thereby aiding in minimizing fogging of the interior lenses of the viewing windows.

Further, the thermoplastic elastomer material may be selected from the group consisting of silicone, thermoplastic polyurethane (TPU), and thermoplastic vulcanizate (TPV).

In accordance with further aspects of an embodiment of the invention, a method for manufacturing a collapsible protective respiratory mask is provided, comprising: forming a main body of the mask from a flexible thermoplastic elastomer material, the main body including a face-engaging flange and viewing windows; forming a plurality of filter panels; attaching a plurality of filter panels to the main body, each filter panel comprising multiple layers of filtration material including an electrostatic filter media and a carbon cloth layer; integrating an inner nose cup within the main body, the inner nose cup having an air opening and an outlet valve for directing airflow; and securing straps to the main body for attachment to a wearer's head. The method may comprise folding the mask along a midline into a flat configuration for placement in a compact storage device.

The step of forming a plurality filter panels may further comprise: (i) layering an outer scratch-resistant mesh layer, a spandex mesh layer, one or more electrostatic filter media layers, a carbon cloth layer, and an additional spandex mesh layer to form a multi-layer filter assembly; (ii) stitching the multi-layer filter assembly around a perimeter of the multi-layer assembly with a fluorescent thread; (iii) encapsulating the stitched perimeter within a urethane gasket in a mold to form a sealed edge; and repeating steps (i)-(iii) for each one of the plurality of filter panels.

The method may further comprise inspecting the filter panels under ultraviolet light to confirm that the fluorescent thread is completely encapsulated by the urethane gasket.

Still other aspects, features and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized. The present invention is illustrated by way of example, and not by way of limitation, in the figures of the accompanying drawings, in which like reference numerals refer to similar elements, and in which:

FIG. 1 is a front view of a protective respiratory mask according to certain aspects of an embodiment of the invention.

FIG. 2 is a side perspective view of the protective respiratory mask of FIG. 1.

FIG. 3 is a rear view of the protective respiratory mask of FIG. 1.

FIG. 4 is a rear perspective view of the protective respiratory mask of FIG. 1.

FIG. 5 is an exploded view of the protective respiratory mask of FIG. 1.

FIG. 6 is a side perspective view of the protective respiratory mask of FIG. 1 in combination with and joined to a protective helmet.

FIGS. 7 and 8 are rear perspective views of female buckles for use in the protective respiratory mask of FIG. 1.

FIG. 9 is a front view of a nose cup for use in the protective respiratory mask of FIG. 1.

FIG. 10 is a rear view of the nose cup of FIG. 9.

FIG. 11 is a side perspective view of the nose cup of FIG. 9.

FIG. 12 is an exploded view of a multi-layer assembly for forming a filter panel for use in the protective respiratory mask of FIG. 1.

FIG. 13 is a top view of an assembled and stitched multi-layer assembly for use in forming a filter panel for use in the protective respiratory mask of FIG. 1.

FIG. 14 is a top view of individual stitched filter pads cut from the multi-layer assembly of FIG. 13.

FIG. 15 is a schematic view of a molding process for forming a filter pad with a perimeter gasket for use in the protective respiratory mask of FIG. 1.

FIG. 16 is a top view of formed filter pads for use in the protective respiratory mask of FIG. 1.

### DETAILED DESCRIPTION OF THE PREFERRED EMBODIMENTS

The invention may be understood by referring to the following description and accompanying drawings. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

Descriptions of well-known functions and structures are omitted to enhance clarity and conciseness. The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item.

The use of the terms “first”, “second”, and the like does not imply any particular order, but they are included to identify individual elements. Moreover, the use of the terms first, second, etc. does not denote any order of importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although some features may be described with respect to individual exemplary embodiments, aspects need not be limited thereto such that features from one or more exemplary embodiments may be combinable with other features from one or more exemplary embodiments.

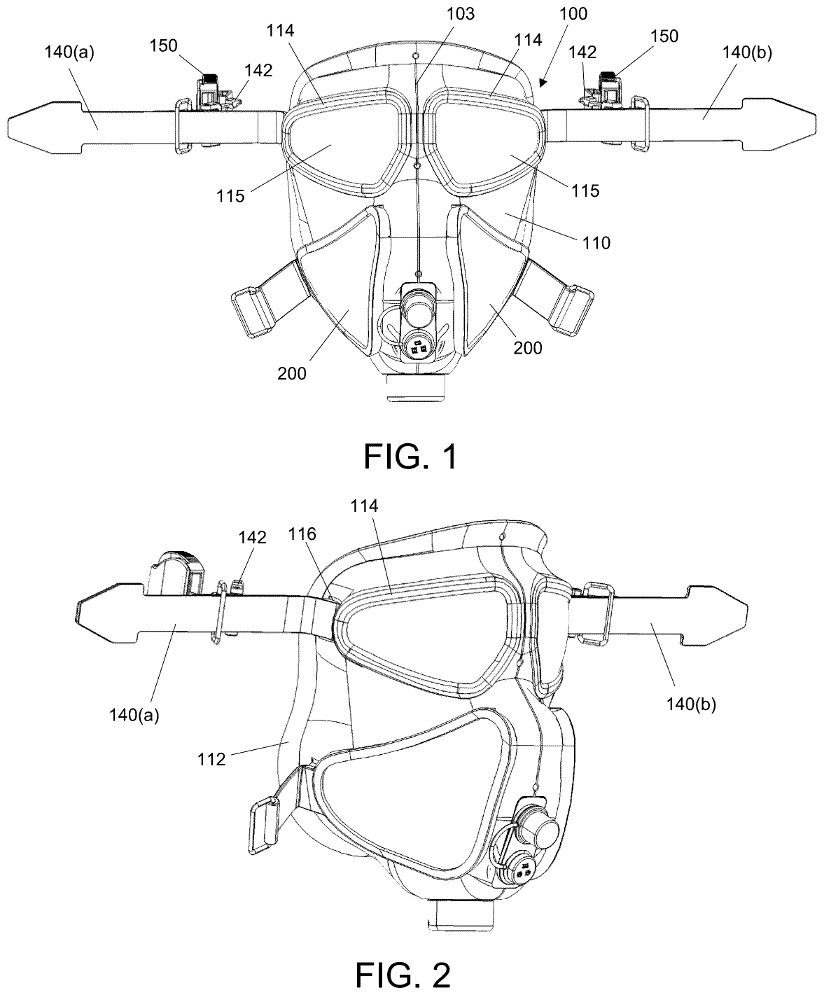

In accordance with certain aspects of an embodiment of the invention and with particular reference to FIGS. 1-5, a protective respiratory mask 100 is shown that is easily foldable into a flat configuration for compact storage and quickly deployable to a user's face. Mask 100 includes a main body 110 having an anatomically contoured face-engaging flange 112 adapted to sit flush against or around a wearer's face, conforming to the contours of the wearer's face to provide a hermetic seal. In an exemplary configuration, main body 110 may be formed of a thermoplastic elastomer material protective against, at a minimum, tear gas and/or CS gas. In certain exemplary configurations, main body 110 may be formed of one or more of silicone, thermoplastic polyurethane (TPU), and thermoplastic vulcanizate (TPV). Viewing windows 114 hold lenses 115 therein to enable the wearer to view a wide range of view when wearing mask 100. As best viewed in FIG. 2, each viewing window 114 preferably extends rearward towards face engaging flange 112, such that only a strap receiver portion 116 sits between viewing window 114 and face engaging flange 112. In certain configurations, viewing windows 114 may extend rearward all the way to face engaging flange 112. In each case, viewing windows 114 and the lenses affixed within viewing windows 114 allow a wide field of view so as to capture preferably the full extent of the wearer's peripheral vision (i.e., preferably greater than 90°, and more preferably at least approximately 110°, in each direction from a centerline between the wearer's eyes).

When worn by a user, air enters the interior of the mask through filter panels 200, the construction of which is further detailed below. Filter panels 200 are particularly configured from materials that are generally readily available (though combined herein in a manner that optimizes filtration of air into mask 100), such that mask 100 overall may economically be employed as a single-use, disposable mask intended for replacement after use in a contaminated environment. Nonetheless in optimal configurations, filter panels 200 may be provided in a modular, replaceable assembly to enable repeated uses of mask 100. In that regard, filter panels 200 may be constructed as modular units that are detachably coupled to the main body, each modular unit comprising a frame and a multi-layered filtration assembly, the frame configured to enable quick replacement of the filtration assembly for repeated use of the mask following contamination exposure.

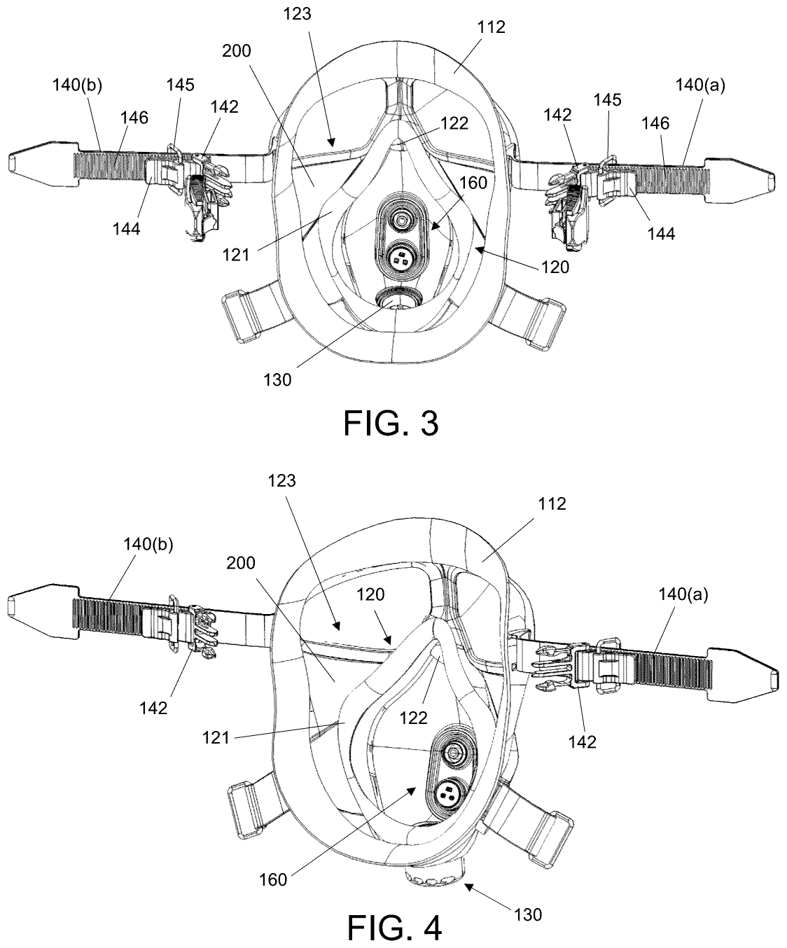

As shown in the rear views of FIGS. 3 and 4, mask 100 includes an inner nose cup 120 having an interior rim 121 configured to sit flush against the wearer's face along a perimeter that is inside of the perimeter of face engaging flange 112, and includes an air opening 122 at the top of inner nose cup 120. With this configuration, as the wearer inhales, air is drawn into the interior of mask 100 through the filter panels 200 into a first enclosed air space 123 between the exterior of inner nose cup 120 and the interior of main body 100, and ultimately into the interior of nose cup 120 through air opening 122, and from there into the wearer's nose or mouth. Upon exhaling, exhaled air is then primarily directed through outlet valve 130, which may comprise a one-way exhalation valve having a configuration that is well known to those skilled in the art. With such configuration, incoming air is drawn through filter panels 200 into the interior of mask 100, and particularly into first enclosed air space 123, upward into the upper interior of the mask 100, and then downward through air opening 122, with exhaled air flowing outward only through outlet valve 130. This configuration creates an airflow that significantly diminishes, if not altogether eliminates, fogging of the interior of lenses 115. In an exemplary embodiment, nose cup 120 also includes a communications and hydration port assembly (discussed in greater detail below) enabling pass through hydration (e.g., water) from an external carrier and connection to external and optionally internal communications and/or other electronic equipment.

As shown in FIGS. 1-5, upper straps 140(a) and 140(b) extend outward in opposite directions from strap receiver portions 116 of main body 110. Each upper strap 140(a) and 140(b) carries a male buckle 142 that is pivotably mounted to a ratchet 144 that in turn is pivotably attached to a D-ring 145, with each D-ring 145 receiving one of upper straps 140(a) and 140(b) extending therethrough. The back of each of upper straps 140(a) and 140(b) are configured with a ridged surface 146 that engages a projecting lip on an underside of each ratchet 144 such that when male buckle 142 is attached to a wearer's helmet, head strap, or other device (as discussed further below) with each upper strap 140(a) and 140(b) pulled tight, ratchet 144 holds male buckle at a fixed position along each upper strap 140(a) and 140(b).

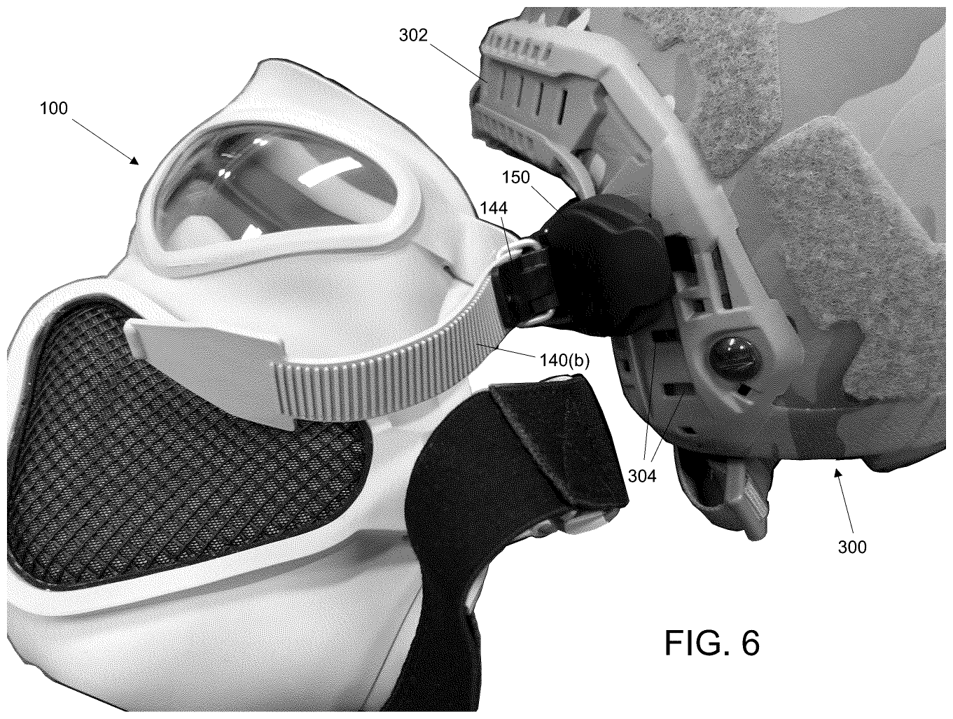

As shown particularly in FIG. 6, female buckles 150 are configured to detachably receive each male buckle 142. Female buckles 150 in turn are configured for attachment to a rail 302 on a protective helmet 300, the construction of which is known to those skilled in the art. In use, the position of attachment of protective respiratory mask 100 to the user, and particularly a user's helmet, may thus be adjusted to best fit the user through simple sliding of female buckle 150 along rail system 302. In certain configurations, instead of connecting female buckle 150 to rail system 302, either male buckles 142 or female buckles 150 may instead connect to a strap (not shown) or other assembly to wrap around the user's head, particularly in those cases in which the user is not wearing a helmet.

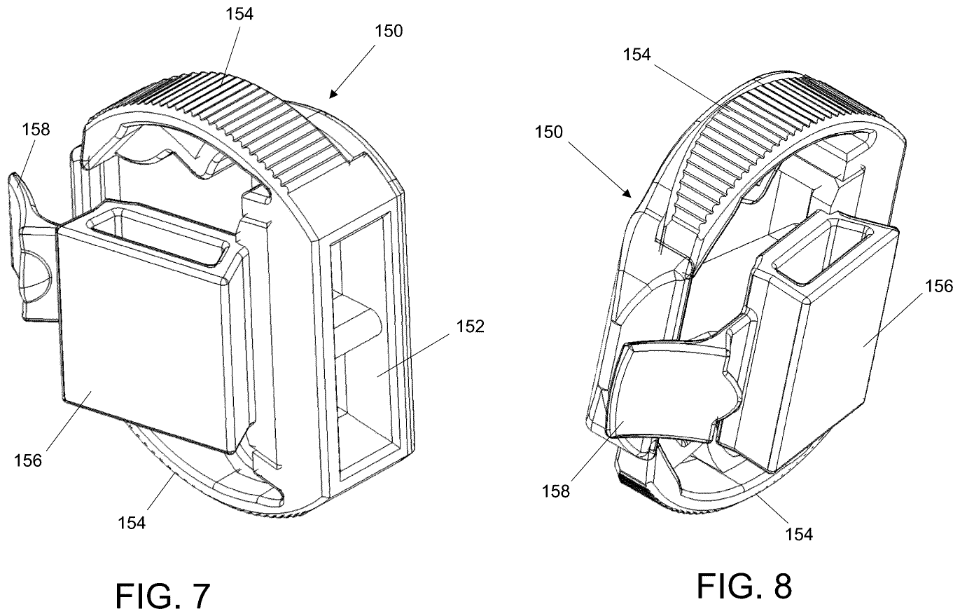

FIGS. 7 and 8 provide detail views of the female buckle 150. In an exemplary configuration, each female buckle 150 includes a receiver 152 configured to receive therein male buckle 142 and enable release of male buckle 142 by squeezing the side spring arms 154 of female buckle 150. A slider block 156 is positioned on an underside of female buckle 150 configured to mate with and slide within rail 302 on protective helmet 300. A slider release tab 158 extends rearward from slider block 156 and is configured to releasably engage openings 304 along rail 302 so as to lock female buckle 150 at a particularly desired location along rail 302, while enabling release and adjustment through simple lifting of slider block release 158.

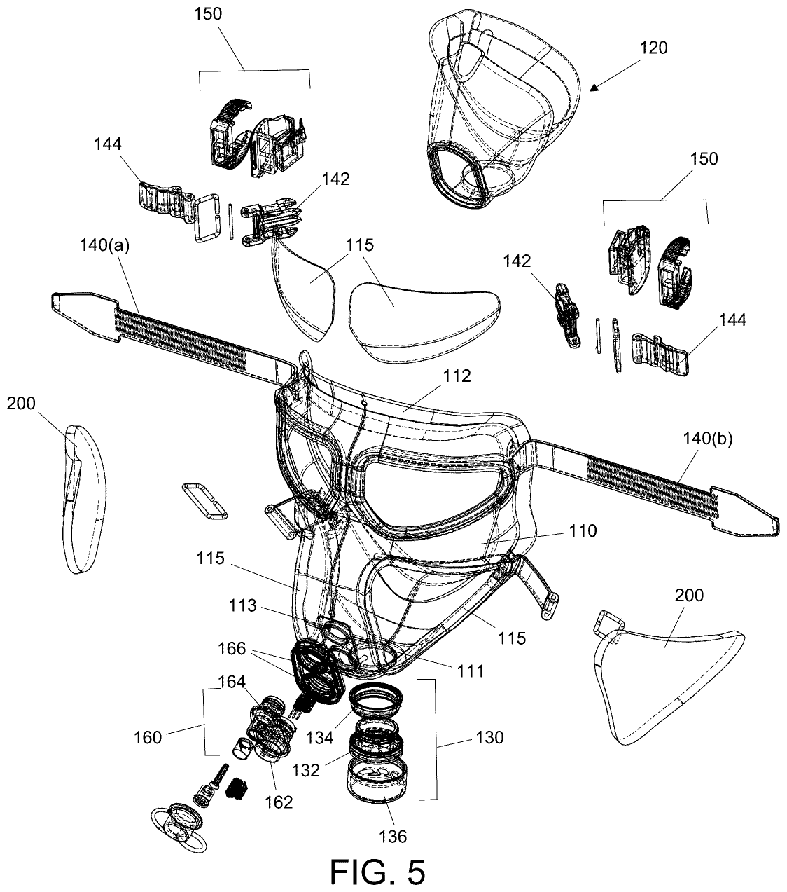

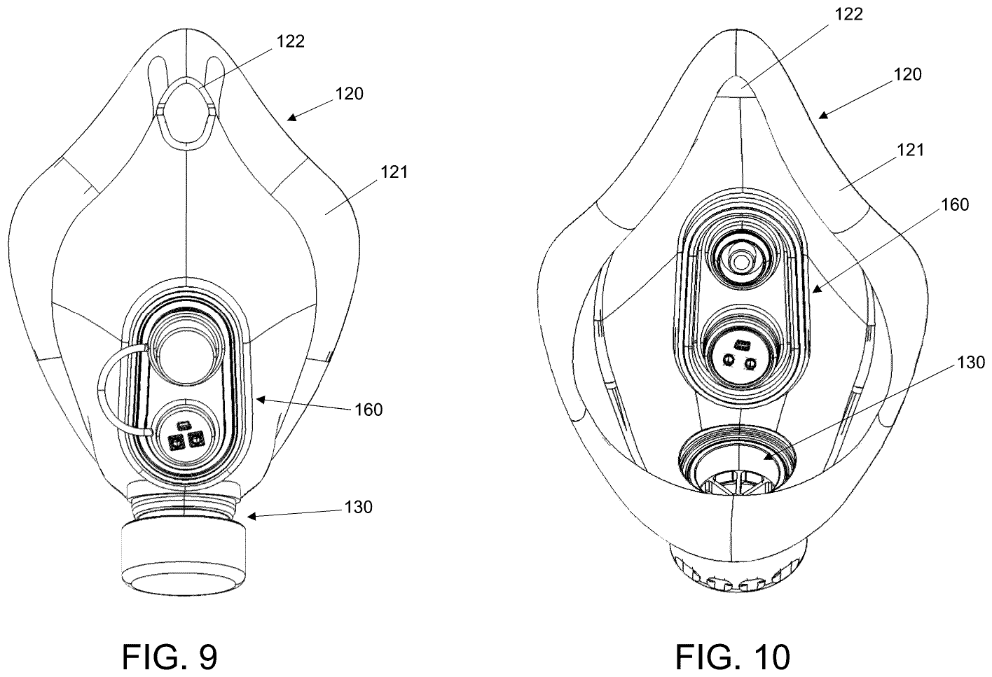

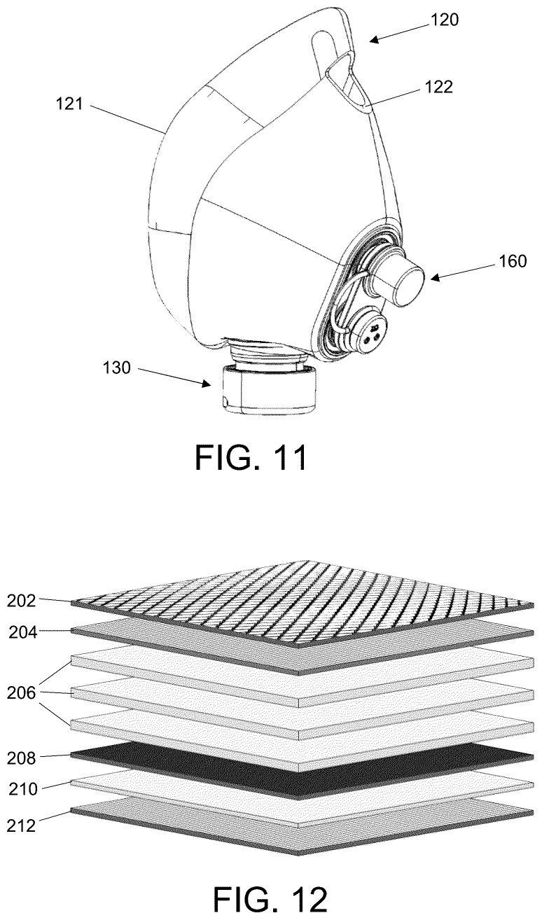

Next, FIGS. 9-11 show font, rear, and perspective views, respectively, of nose cup 120 in accordance with further aspects of the invention. Nose cup 120 is preferably formed of the same thermoplastic elastomer material as main body 110 of mask 100. Thus, when nose cup 120 is positioned within main body 110 of mask 100, the combined assembly of main body 110 and nose cup 120 remains foldable about a midline 103 (FIG. 1) running from the top to the bottom of mask 100. While most of nose cup 120 is positioned within main body 110, outlet valve assembly 130 extends through an opening 111 (FIG. 5) in the bottom of main body 110, and ports of communications and hydration plate 160 extend through openings 113 in the front face of main body 110 along midline 103. Those ports are configured to establish a sealed connection with external devices (e.g., external communication devices and hydration equipment). With particular reference to FIG. 5, outlet valve 130 includes an outlet valve body 132 configured as a one-way exhalation valve of standard configuration allowing exhaled air to exit from the interior of mask 110 while preventing inflow of air into the interior of mask 110. Outlet valve body 132 has an interior side that is on the interior of mask 100, and an exterior side that extends outward from mask 100, such that valve body 132 extends through opening 111 from the interior of mask 100 to the exterior of mask 100. Valve body 132 may be held to opening 111 via a snap ring 134, and may be covered at its exterior side with preferably a threaded outlet valve body cover 136 that may be readily removed by a user when the mask 100 is in use. Likewise and with continued reference to FIG. 5, communications and hydration plate 160 holds a communications port 162 and a hydration port 164, both having standard configurations known to those skilled in the art. Each of communications port 162 and hydration port 164 has an exterior portion for connection to a communications signal cable (not shown) and a hydration supply line (not shown), and an interior portion inside of mask 100 for connection to the user's communications equipment (e.g., microphone and the like) and individual hydration line inside of the mask. A snap ring 166 holds communications and hydration plate 160 in place on the front of mask 100 with each of communications port 162 and hydration port 164 extending through openings 113 on the front of mask body 110.

Next and as mentioned above, air coming into the interior of mask 100 is drawn exclusively through filter panels 200 covering each of two filter panel openings 115 on opposing sides of mask body 100. As discussed in greater detail below, each filter panel 200 is composed of multiple layers that are sewn together and thereafter placed into a mold that captures the edges of the filter panel 200 in a urethane gasket.

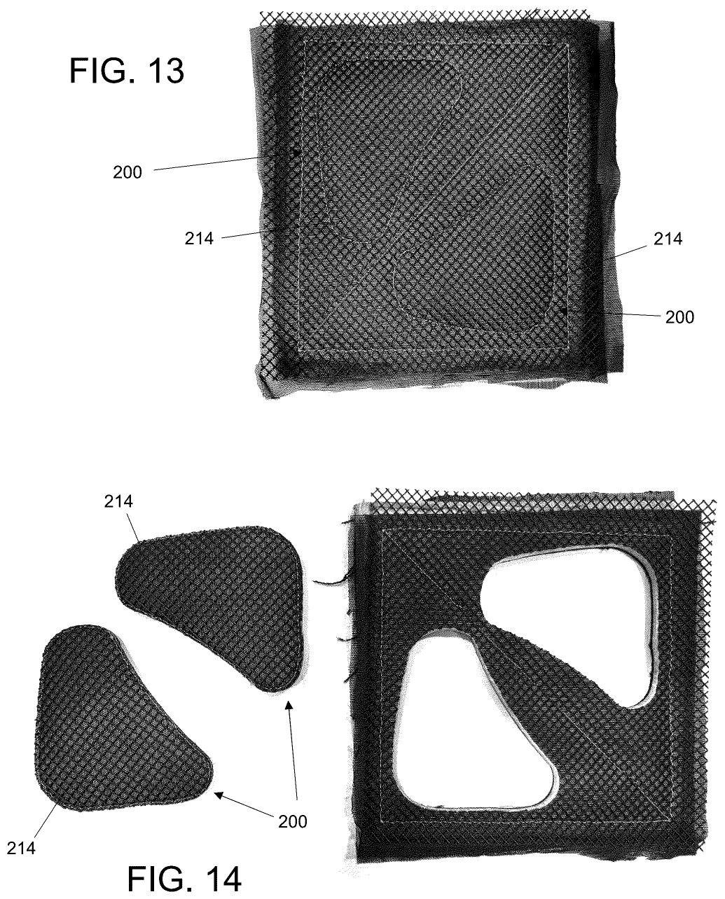

FIG. 12 is an exploded view of the layers that form each filter panel 200. An outer layer 202 is formed from a planar section of scratch resistant mesh, and more particularly an abrasion-resistant polymeric mesh. Below layer 202 is a layer 204 of soft spandex mesh, which in turn covers preferably multiple, and in an exemplary configuration three, layers 206 of electrostatic filter media, such as white TECHNOSTAT filter media. Below the multiple layers of TECHNOSTAT filter media 206 is a layer of carbon cloth 208, followed by another thin, electrostatic (e.g., white TECHNOSTAT) filter media layer 210, and finally an outer soft spandex mesh layer 212 on the user-facing side of the filter panel 200. As shown in FIG. 13, those layers 202-212 of filter panel 200 are preferably stitched together, such as on an embroidery machine, to stitch out a precisely sized and positioned border 214 for each filter panel 200. A bright fluorescent thread, such as a fluorescent yellow thread, is used to create the stitched border 214 around the layers of filter panel 200 in this manner for purposes described in further detail below. As shown in FIG. 14, individual filter panels 200 are cut, such as through use of a precise cutting die (not shown), so that an outer edge of each such filter panel 200 is just outside of the continuous perimeter of stitched border 214. The fluorescent thread at this point enables visual inspection to ensure that the fluorescent thread border is properly holding all layers together, and to confirm that its placement within the mold will result in the stitched border 214 being fully covered with urethane during the molding process.

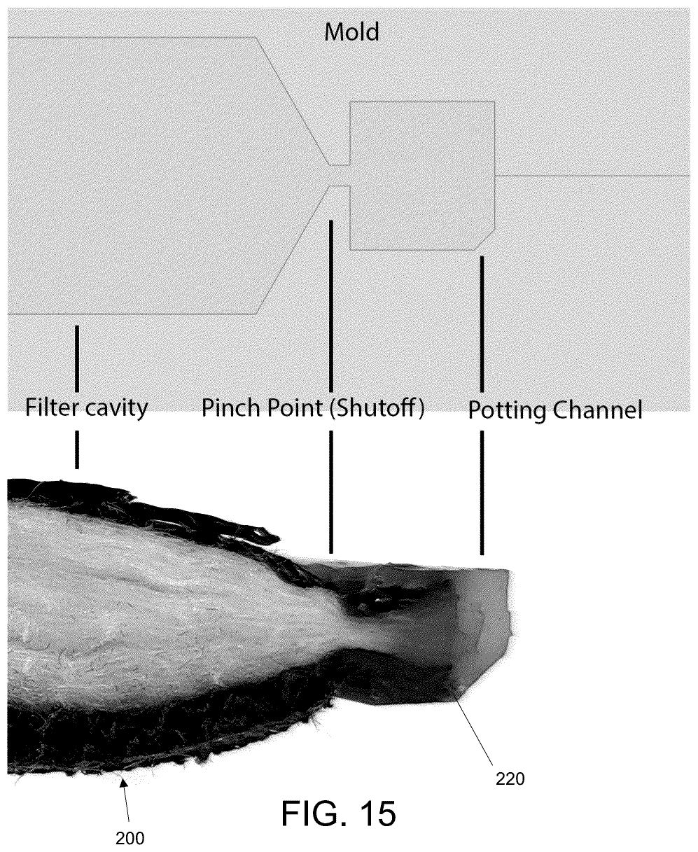

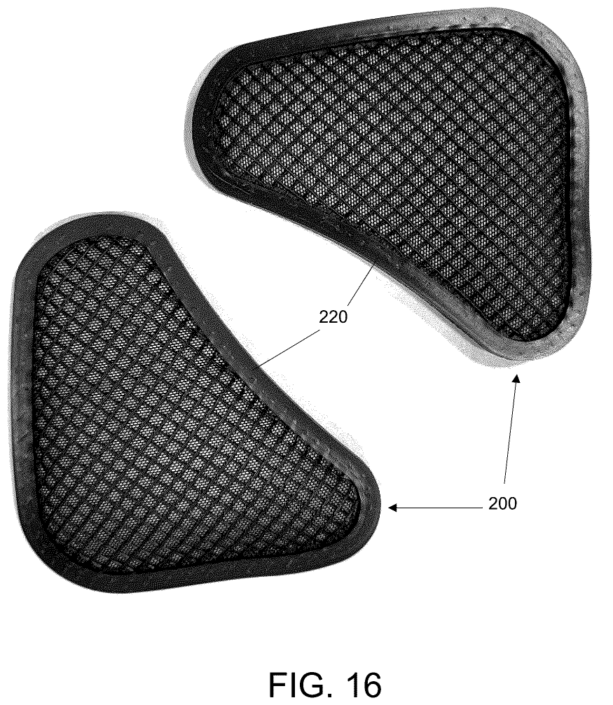

Each filter panel 200 is then placed into a mold that captures the outer edges, and particularly the stitched outer perimeter, of each filter panel 200 in a urethane gasket 220 (FIG. 16). The mold is configured to carefully cradle the center of filter panel 200, giving it ample room to rest without damage. At the same time, the mold compresses the filter panel 200 near its outer edge tight enough to shutoff a urethane pour from bleeding into the usable filter space. More particularly and as shown in FIG. 15, the pinch of filter panel 200 by the mold near its outer edge splays the very end of the filter panel 200, increasing its surface area and allowing the urethane to completely wet and encapsulate the edge of the filter panel 200. FIG. 15 shows the fanning and wetting of the edge of filter panel 200 (showing a clear urethane for clarity of illustration). After such molding process, the filter panel 200 with gasket 220 formed around its outer edge is removed from the mold and inspected to confirm that every stitch made by the above-described stitching process is captured under the urethane (as any stitch not covered in urethane is a pinhole in the filer panel 200, reducing if not altogether destroying the effectiveness of the filter panel 200). The fluorescent thread (which is preferably now virtually invisible to the naked eye) will shine brightly under an ultraviolet light, enabling confirmation that the stitched edging is completely captured by the urethane.

The foregoing assembly provides a respiratory mask 100 capable of collapsed storage by folding the mask body 110 about midline 103 into a compact, flat package which may then be stored in, by way of non-limiting example, a pocket, pouch or carrying case of a size smaller than the deployed mask 100. The mask 100 may likewise be quickly deployed to its full, open shape for donning by a user when needed to protect against a harsh environment. This assembly results in a protective respiratory mask that is thus easier to use than traditional respiratory masks, and the configuration of filter pads 200 as described above provide for the option of a disposable construction.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention may be practiced otherwise than as specifically set forth herein.

1. A protective respiratory mask system, comprising:
a main body constructed from a thermoplastic elastomer material, the main body including an anatomically contoured face-engaging flange configured to conform to the contours of a wearer's face to provide a hermetic seal;
a pair of viewing windows integrated into the main body, each window configured to provide a field of view capturing great than 90° in each direction from a centerline between the wearer's eyes;
a plurality of filter panels attached to the main body on opposite sides, each filter panel comprising multiple layers of filtration material including an electrostatic filter media and a carbon cloth layer, the filter panels configured to allow air passage into the mask while filtering environmental contaminants;
an inner nose cup positioned within the main body and having an interior rim designed to sit flush against the wearer's face, the inner nose cup including an air opening for directing inhaled air from an interior side of the filter panels into the interior of the inner nose cup;
an outlet valve integrated with the inner nose cup for directing exhaled air out of the mask; and
a set of straps extending outward from the main body for securing the mask to the wearer's head.

2. The system of claim 1, wherein the filter panels further comprise:
an outer layer of abrasion-resistant polymeric mesh;
an inner layer of spandex mesh; and
a urethane gasket encapsulating the perimeter of the filter panels.

3. The system of claim 2, wherein the urethane gasket encapsulating the perimeter of the filter panels is formed using a liquid injection molding process that ensures airtight sealing and prevents delamination of the filter panel layers.

4. The system of claim 2, wherein the outer layer of the filter panels is reinforced with a tear-resistant weave pattern that maintains structural integrity even when subjected to rough handling or snagging.

5. The system of claim 1, wherein the filter panels are constructed as modular units that are detachably coupled to the main body, each modular unit comprising a frame and a multi-layered filtration assembly, the frame configured to enable quick replacement of the filtration assembly for repeated use of the mask following contamination exposure.

6. The system of claim 1, wherein the inner nose cup further comprises:
an integrated communications interface with a port configured to establish a sealed connection with external communication devices; and
a hydration port configured to establish a sealed connection with an external hydration source.

7. The system of claim 1, wherein the straps include adjustable buckles with locking mechanisms, the buckles being configured for secure engagement with a standardized rail system on a protective helmet or other headgear.

8. The system of claim 7, wherein the straps include a fine-adjustment mechanism that allows for incremental tightening or loosening to achieve a custom fit for various head sizes and shapes.

9. The system of claim 1, wherein the main body and the inner nose cup are formed of a thermoplastic elastomer material protective against environmental contaminants including tear gas and CS gas.

10. The system of claim 1, wherein the mask is collapsible along a midline of the mask for compact, flat storage and rapid deployment.

11. The system of claim 1, wherein the filter panels are stitched with a fluorescent thread around an outer perimeter of each filter panel.

12. The system of claim 11, wherein the thread is encased in a urethane gasket encapsulating a perimeter of each of the filter panels, and wherein the thread is visible through the gasket under ultraviolet light to ensure the integrity of the filter panels.

13. The system of claim 1, wherein the outlet valve comprises a one-way exhalation valve configured to prevent inflow of air and to direct exhaled air out of the mask, thereby aiding in minimizing fogging of the interior lenses of the viewing windows.

14. The system of claim 1, wherein the thermoplastic elastomer material is selected from the group consisting of silicone, thermoplastic polyurethane (TPU), and thermoplastic vulcanizate (TPV).

15. A method for manufacturing a collapsible protective respiratory mask, comprising:
forming a main body of the mask from a flexible thermoplastic elastomer material, the main body including a face-engaging flange and viewing windows;
forming a plurality of filter panels;
attaching a plurality of filter panels to the main body, each filter panel comprising multiple layers of filtration material including an electrostatic filter media and a carbon cloth layer;
integrating an inner nose cup within the main body, the inner nose cup having an air opening and an outlet valve for directing airflow; and
securing straps to the main body for attachment to a wearer's head.

16. The method of claim 15, further comprising folding the mask along a midline into a flat configuration for placement in a compact storage device.

17. The method of claim 15, wherein the step of forming a plurality filter panels further comprises:
(i) layering an outer scratch-resistant mesh layer, a spandex mesh layer, one or more electrostatic filter media layers, a carbon cloth layer, and an additional spandex mesh layer to form a multi-layer filter assembly;
(ii) stitching said multi-layer filter assembly around a perimeter of the multi-layer assembly with a fluorescent thread;
(iii) encapsulating the stitched perimeter with a urethane gasket in a mold to form a sealed edge; and
repeating steps (i)-(iii) for each one of said plurality of filter panels.

18. The method of claim 17, further comprising:
inspecting the filter panels under ultraviolet light to confirm that the fluorescent thread is completely encapsulated by the urethane gasket.
